(19) United States
(12) Patent Application Publication
(10) Pub. No.: US 2025/0119720 A1
(43) Pub. Date: Apr. 10, 2025

(54) ACCESS NETWORK NODE, METHOD FOR ACCESS NETWORK NODE, AND NETWORK SYSTEM

(71) Applicant: NEC Corporation, Minato-ku, Tokyo (JP)

(72) Inventors: Toshiyuki TAMURA, Tokyo (JP); Hisashi FUTAKI, Tokyo (JP)

(73) Assignee: NEC Corporation, Minato-ku, Tokyo (JP)

(21) Appl. No.: 18/729,216

(22) PCT Filed: Feb. 10, 2022
(86) PCT No.: PCT/JP2022/005303

§ 371 Date: Jul. 16, 2024

(51) Int. Cl. H04W 4/90; H04W 48/02; H04W 84/04

(52) U.S. Cl. CPC H04W 4/90; H04W 48/02; H04W 84/042

(57) ABSTRACT

An access network node (12) is connected to a first core network (15) of a first Public Land Mobile Network (PLMN) (10) and to a second core network (25) of a second PLMN (20). In response to a disaster condition being applied to an area to which a cell of the access network node (12) belongs or in response to an increase in load on the first core network, the access network node (12) restricts access to the cell from User Equipments (UEs) (32) using the second core network (25) and prioritizes access to the cell from UEs (31) using the first core network (15). This allows, for example, users of one PLMN to have priority over users of another PLMN to use a shared radio access network when necessary, such as in the event of a disaster.

### TECHNICAL FIELD

The present disclosure relates to wireless communication networks.

### BACKGROUND ART

The 3rd Generation Partnership Project (3GPP) Long Term Evolution (LTE) systems and 5th Generation Mobile Communications (5G) systems support a Multi-Operator Core Network (MOCN) (see, for example, Non-Patent Literature 1, Chapter 5.18). MOCN is a network sharing technology defined in the 3GPP specifications that allows multiple operators or core network operators to share a radio access network (RAN). In MOCN, not only RAN equipment (e.g., eNBs, gNBs) but also radio frequencies (or cells) are shared among multiple core network operators.

Non-Patent Literature 2 discusses the support of Minimization of Service Interruption (MINT) by 5G systems and provides key issues and solutions for supporting MINT. Some of the solutions are related to RAN sharing. For example, in Solution #10 described in Chapter 6.10 of Non-Patent Literature 2, when a disaster condition applies, a RAN node in a Public Land Mobile Network (PLMN) without the disaster condition is shared between the PLMN without the disaster condition and a PLMN with the disaster condition. In this case, User Equipments (UEs) that were served by the PLMN with the disaster condition can register to the same PLMN (i.e., the PLMN with the disaster condition) through the shared RAN.

### CITATION LIST

### Patent Literature

[Patent Literature 1] JP 2015-525540 A

### Non-Patent Literature

[Non-Patent Literature 1] 3GPP TS 23.501 V17.3.0 (2021-12) “3rd Generation Partnership Project: Technical Specification Group Services and System Aspects: System architecture for the 5G System (5GS): Stage 2 (Release 17)”, December 2021
[Non-Patent Literature 2] 3GPP TR 24.811 V17.1.0 (2021-09) “3rd Generation Partnership Project: Technical Specification Group Core Network and Terminals: Study on the support for minimization of service interruption: (Release 17)”, September 2021

### SUMMARY OF INVENTION

### Technical Problem

The inventors have studied the use of RAN sharing, including MOCN, primarily for communications of government agencies and public safety, public protection, and/or disaster relief organizations, and have identified several problems. One of the problems relates to cases where the communications of government and/or public safety users and the communications of commercial users share a common RAN. It is desirable that users of one PLMN (e.g., government and public safety users) have priority over users of the other PLMN (e.g., commercial users) to use the shared RAN when necessary, such as in the event of a disaster. Another one of the problems relates to how to specifically configure a network that is shared between government and/or public safety user communications and commercial user communications using RAN sharing.

By the way, Patent Literature 1 (e.g., paragraphs 0170-0178) discloses the use of roaming concepts to differentiate government agency users from general users in a dual-use network. Specifically, a government agency user is assigned an International Mobile Subscription Identity (IMSI) value in the home network or its equivalent network of the dual-use network. On the other hand, all other users are assigned IMSI values in networks of network operators other than the dual-use network and can access the dual-use network as roamers. During an emergency, or when deemed necessary by the government administrator, access to one, multiple, or all cells of the dual-use network can be restricted to government users only. This is accomplished by having an Element Management System (EMS) provision a Mobility Management Entity (MME) in the dual-use network to remove the list of allowed roaming networks. That is, Patent Literature 1 only discloses the case where general users use a dual-use network as roamers. In other words, Patent Literature 1 does not disclose the use of RAN sharing such as MOCN.

One of the objects to be achieved by the example embodiments disclosed herein is to provide apparatuses, methods, and programs that contribute to solving at least one of the above-described problems. It should be noted that this object is merely one of the objects to be achieved by the example embodiments disclosed herein. Other objects or problems and novel features will become apparent from the following description and the accompanying drawings.

### Solution to Problem

In a first aspect, an access network node includes a first communication interface, a second communication interface, and at least one processor. The first communication interface is configured to communicate with a plurality of User Equipments (UEs) through a cell. The second communication interface is configured to be connected to a first core network of a first Public Land Mobile Network (PLMN) and to a second core network of a second PLMN different from the first PLMN. The at least one processor is configured to forward a Non-Access Stratum message that is sent from a UE and is associated with the first PLMN to the first core network, and to forward a Non-Access Stratum message that is sent from a UE and is associated with the second PLMN to the second core network. The at least one processor is further configured to restrict access to the cell from UEs using the second core network and prioritize access to the cell from UEs using the first core network in response to a disaster condition being applied to an area to which the cell belongs or an increase in load on the first core network.

In a second aspect, a method performed by an access network node includes the steps of:
(a) connecting to a first core network of a first Public Land Mobile Network (PLMN) and to a second core network of a second PLMN different from the first PLMN:
(b) communicating with a plurality of User Equipments (UEs) through a cell:
(c) forwarding a Non-Access Stratum message that is sent from a UE and is associated with the first PLMN to the first core network, and forwarding a Non-Access Stratum message that is sent from a UE and is associated with the second PLMN to the second core network; and
(d) restricting access to the cell from UEs using the second core network and prioritizing access to the cell from UEs using the first core network in response to a disaster condition being applied to an area to which the cell belongs or an increase in load on the first core network.

In a third aspect, a program includes a set of instructions (software codes) that, when loaded into a computer, cause the computer to perform the method according to the second aspect described above.

In a fourth aspect, a network system includes a core network of a non-commercial Public Land Mobile Network (PLMN) administered by a public authority and a non-commercial radio access network node administered by the public authority. The non-commercial radio access network node is connected to the core network of the non-commercial PLMN and to a core network of a commercial PLMN administered by a commercial operator. The non-commercial radio access network node is configured to forward a Non-Access Stratum message that is sent from a User Equipment (UE) and is associated with the non-commercial PLMN to the core network of the non-commercial PLMN, and to forward a Non-Access Stratum message that is sent from a UE and is associated with the commercial PLMN to the core network of the commercial PLMN.

### ADVANTAGEOUS EFFECTS OF INVENTION

According to the aspects described above, it is possible to provide apparatuses, methods and programs that contribute to solving at least one of the problems described above.

### BRIEF DESCRIPTION OF DRAWINGS

FIG. 1 shows an example configuration of a network system according to an example embodiment:

FIG. 2 is a flowchart showing an example of the operation of a RAN node according to an example embodiment;

FIG. 3 is a flowchart showing an example of the operation of a RAN node according to an example embodiment:

FIG. 4 is a sequence diagram showing an example of the operation of a RAN node and a core network node according to an example embodiment:

FIG. 5 is a flowchart showing an example of the operation of a RAN node according to an example embodiment:

FIG. 6 is a sequence diagram showing an example of the operations of a RAN node and a core network node according to an example embodiment:

FIG. 7 shows an example configuration of a network system according to an example embodiment:

FIG. 8 is a diagram showing an example configuration of a RAN node according to an example embodiment: and

FIG. 9 is a diagram showing an example configuration of a core network node according to an example embodiment.

### EXAMPLE EMBODIMENT

Specific example embodiments will be described hereinafter in detail with reference to the drawings. The same or corresponding elements are denoted by the same symbols throughout the drawings, and duplicated explanations are omitted as necessary for the sake of clarity.

Each of the example embodiments described below may be used individually, or two or more of the example embodiments may be appropriately combined with one another. These example embodiments include novel features different from each other. Accordingly, these example embodiments contribute to attaining objects or solving problems different from one another and contribute to obtaining advantages different from one another.

The example embodiments presented below are primarily described for the 3GPP LTE system and the 5G system. However, these example embodiments can be applied to other network systems, such as network systems that support technologies similar to 3GPP RAN sharing (e.g., MOCN). The term LTE as used in this specification includes enhancements and developments of LTE and LTE-Advanced to enable interworking with the 5G system, unless otherwise noted.

As used in this specification, “if” can be interpreted to mean “when”, “at or around the time”, “after”, “upon”, “in response to determining”, “in accordance with a determination”, or “in response to detecting”, depending on the context.

### First Example Embodiment

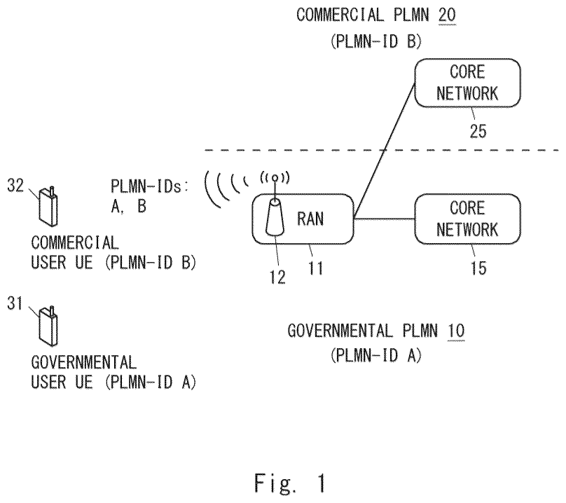

FIG. 1 shows an example configuration of a network system according to this example embodiment. Each of the elements shown in FIG. 1 is a network function, for example providing an interface as defined by 3GPP. Each element (or network function) shown in FIG. 1 can be implemented, for example, as a network element on dedicated hardware, as a software instance running on dedicated hardware, or as a virtualized function instantiated on an application platform.

The network system shown in FIG. 1 includes a RAN 11 and a core network 15. The RAN 11 may be a Next Generation Radio Access Network (NG-RAN), an Evolved Universal Mobile Telecommunications System (UMTS) Terrestrial Radio Access Network (E-UTRAN), or a radio access network in another network system, or any combination thereof. The core network 15 may be a 5G Core (5GC), an Evolved Packet Core (EPC), or a core network in another network system, or any combination thereof.

The RAN 11 includes one or more RAN nodes 12. The one or more RAN nodes 12 may be gNBs or eNBs, or both. The core network 15 includes one or more core network nodes. These core network nodes include one or more control plane nodes and one or more user plane (or data plane) nodes. In the case of a 5G system, the control plane nodes include an Access and Mobility Management Function (AMF), a Session Management Function (SMF), and other nodes (e.g., Unified Data Management (UDM) and Policy Control Function (PCF)), while the user plane nodes include a User Plane Function (UPF). In the case of an LTE system, the control plane nodes include a Mobility Management Entity (MME) and other nodes (e.g., Home Subscriber Server (HSS) and Policy and Charging Rules Function (PCRF)), while the user plane nodes include a Serving Gateway (S-GW) and a Packet Data Network Gateway (P-GW).

As an example and not a limitation, the RAN 11 and the core network 15 may be provided by a governmental PLMN 10 administered by a government authority, as shown in FIG. 1. In other words, the RAN 11 and the core network 15 may be network elements belonging to the governmental PLMN 10. The government authority may be a national, federal, state, or local government authority. In this case, the RAN 11 may be referred to as a governmental RAN and the core network 15 may be referred to as a governmental core network. Alternatively, the RAN 11 and the core network 15 may be provided by another public agency, such as a public safety, public protection, or disaster relief organization. In other words, the RAN 11 and the Core Network 15 may be provided by a PLMN managed by such a public agency.

The RAN 11 supports RAN sharing, allowing multiple core network operators, including the governmental PLMN 10, to share one or more RAN nodes 12. As an example, the RAN 11 may support Multi-Operator Core Network (MOCN) as specified in the 3GPP specification. As explained above, in MOCN, not only RAN equipment (e.g., one or more RAN nodes 12), but also radio frequencies (or cells) may be shared among multiple core network operators.

As an example and not a limitation, the RAN 11 may be shared by multiple core network operators, including the governmental PLMN 10 and a commercial PLMN 20, as shown in FIG. 1. The commercial PLMN 20 is a PLMN administered by a commercial operator.

A UE 31 is a governmental user UE. There may be a plurality of UEs 31. The Home PLMN (HPLMN) or Equivalent HPLMN (EHPLMN) of the UE 31 may be the governmental PLMN 10. Alternatively, the HPLMN of the UE 31 may be a PLMN of another governmental or public authority that has a roaming agreement with the governmental PLMN 10. The UE 31 may be a UE authorized to register as an inbound roamer with the governmental PLMN 10. On the other hand, a UE 32 is a commercial user UE. There may be a plurality of UEs 32. The Home PLMN (HPLMN) or Equivalent HPLMN (EHPLMN) of the UE 32 may be the commercial PLMN 20. Alternatively, the HPLMN of the UE 32 may be another (commercial) PLMN that has a roaming agreement with the commercial PLMN 20. The UE 32 may be a UE authorized to register as an inbound roamer with the commercial PLMN 20.

In the example in FIG. 1, the PLMN identity (ID) of the governmental PLMN 10 is “A” and the PLMN ID of the commercial PLMN 20 is “B”. The RAN node 12 in the government RAN 11 broadcasts system information containing a set or list of PLMNs in its cell. The set or list of PLMNs indicates the PLMNs that are available in the cell. The set or list of PLMNs may be referred to as a PLMN list. In the example in FIG. 1, the RAN node 12 broadcasts a PLMN list containing PLMN IDs “A” and “B”

The RAN node 12 forwards a Non-Access Stratum (NAS) message sent by the governmental user UE 31 and associated with the governmental PLMN 10 (i.e., PLMN ID “A”) to the core network 15 of the governmental PLMN 10. The NAS message may be, for example, a Registration Request message or a Service Request message. The NAS message can be associated with the PLMN ID “A” by being included with the PLMN ID “A” in a Radio Resource Control (RRC) message. Specifically, the RAN node 12 receives from the UE 31 an RRC message, e.g., RRC Setup Complete message, containing the NAS message. The RRC Setup Complete message contains the PLMN ID “A” or another identifier that contains the PLMN ID “A”, e.g., Globally Unique AMF ID (GUAMI).

Similarly, the RAN node 12 forwards a NAS message sent from the commercial user UE 32 and associated with the commercial PLMN 20 (i.e., PLMN ID “B”) to the core network 25 of the commercial PLMN 20. The NAS message may be, for example, a Registration Request message or a Service Request message. The NAS message can be associated with the PLMN ID “B” by being included with the PLMN ID “B” in an RRC message (e.g., RRC Setup Complete message).

In the network arrangement illustrated in FIG. 1, one or more RAN nodes 12 of the governmental RAN 11 may be deployed to provide coverage to important buildings or areas of government authorities. The RAN node 12 may be equipped with a battery of sufficient capacity to continue service in the event of a loss of power due to a natural or human-caused disaster (e.g., flood, earthquake, tsunami, volcanic eruption, fire, gas explosion). This allows the RAN 11 and the core network 15 of the governmental PLMN 10 to improve the continuity or robustness of communication services to governmental users UE 31 in the event of a disaster.

In the network arrangement illustrated in FIG. 1, the RAN 11 provided by the government agency can not only provide access to the governmental PLMN 10 to the governmental user UE 31, but also provide access to the commercial PLMN 20 to the commercial user UE 32. In one example, the RAN node 12 in the governmental PLMN 10 may continue to provide communication services (or connectivity) to the commercial user UE 32 even during a disaster. In other words, the RAN node 12 may continue to provide communication services (or connectivity) to the commercial user UE 32 even after a disaster condition is applied to the area to which the cell served by the RAN node 12 belongs. The disaster condition is related to a natural or human-caused disaster. The disaster condition may be a condition under which a government agency determines when a disaster begins and ends. This gives the commercial user UE 32 the opportunity to mitigate communication interruptions and disruptions caused by disasters.

In contrast, in another example, in the event of a disaster, the RAN node 12 in the governmental PLMN 10 may reduce or suspend communication services to the commercial user UE 32, thereby prioritizing communication services to the governmental user UE 31.

### Second Example Embodiment

An example configuration of a network system according to this example embodiment is the same as the example shown in FIG. 1. In this example embodiment, the RAN node 12 of the governmental PLMN 10 reduces or suspends communication services to the commercial user UE 32, when necessary, thereby providing communication services to the governmental user UE 31 with priority.

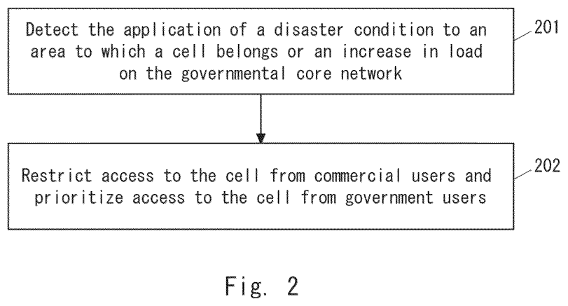

FIG. 2 shows an example of the operation of the RAN node 12 in the governmental PLMN 10.

In step 201, the RAN node 12 detects (or determines) the application of a disaster condition to an area to which a cell served by the RAN node 12 belongs or an increase in load on the government core network 15. The disaster condition is related to a natural or human-caused disaster. The disaster condition may be a condition that a government authority determines when a disaster begins and ends.

In step 202, in response to the detection (or determination) of step 201, the RAN node 12 restricts access to the cell from the commercial user UE 32 and prioritizes access to the cell from the government user UE 31.

In some implementations, the RAN node 12 stops broadcasting the PLMN ID of the commercial PLMN 20 in the cell to restrict access to the RAN node 12 from UEs 32 using the core network 25 of the commercial PLMN 20. This allows the RAN node 12 to inform the UEs 32 that the cell is unavailable to the commercial PLMN 20. In addition, the RAN node 12 may reject the RRC setup of the commercial user UEs 32. Additionally or alternatively, the RAN node 12 may release RRC connections of the commercial user UEs 32.

In other implementations, the RAN node 12 updates at least one access control parameter to restrict access to the RAN node 12 from UEs 32 using the core network 25 of the commercial PLMN 20. The at least one access control parameter is broadcast in the cell and used for an access barring check by the UEs 32 using the core network 25 of the commercial PLMN 20. Specifically, the RAN node 12 may adjust at least one of the Unified Access Control (UAC) barring parameters (e.g., uac-BarringFactor) per PLMN. The uac-BarringFactor represents the probability that an access attempt is allowed during an access barring check by a UE. The RAN node 12 may reduce the probability represented by the uac-BarringFactor associated with the commercial PLMN 20, thereby reducing the total number of access attempts by commercial user UEs 32.

In one example, the RAN node 12 may determine the application of a disaster condition to the cell based on the receipt of a request to transmit urgent system information. Such urgent system information may be, for example, a warning message from a Public Warning System (PWS). In the case where the RAN node 12 is an NG-RAN node (e.g., gNB) in a 5G system, the RAN node 12 is responsible for broadcasting a warning message and is responsible for paging UEs to provide an indication (i.e., ETWS/CMAS indication) that the warning message is being broadcast. The PWS includes an Earthquake and Tsunami Warning System (ETWS) and a Commercial Mobile Alert System (CMAS). ETWS warning notifications include a primary notification (or short notification) and a secondary notification (or detailed information). Different SIBs may be defined for an ETWS primary notification, an ETWS secondary notification, and a CMAS notification. In particular, in the case where the RAN node 12 is an NG-RAN node (e.g., gNB) in a 5G system, SIB6 may contain an ETWS primary notification, SIB7 may contain an ETWS secondary notification, and SIB8 may contain a CMAS notification. When the RAN node 12 is a RAN node (e.g., eNB) in an LTE system, SIB10 may contain an ETWS primary notification, SIB11 may contain an ETWS secondary notification, and SIB12 may contain a CMAS notification.

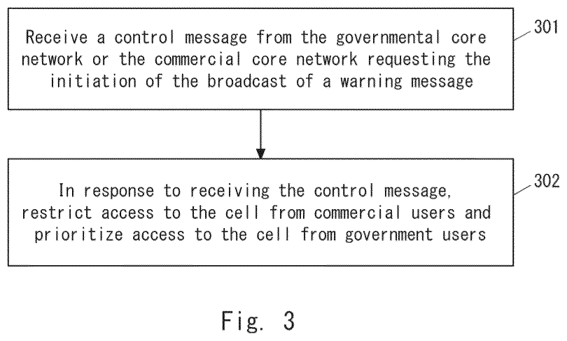

FIG. 3 shows an example of access control operation in a cell based on the broadcast of a warning message.

In step 301, the RAN node 12 receives a control message from the governmental core network 15 or the commercial core network 25 requesting the initiation of the broadcast of a warning message. In the case of a 5G system, the control message may be a WRITE-REPLACE WARNING REQUEST message sent from an AMF to an NG-RAN node (e.g., gNB). The WRITE-REPLACE WARNING REQUEST message may contain a Warning Area List information element. The Warning Area List information element indicates the areas where the warning message should be broadcast. The Warning Area List information element indicates one or more Cell IDs, one or more Tracking Area Identities (TAIs), or one or more Emergency Area IDs. Additionally or alternatively, the WRITE-REPLACE WARNING REQUEST message may contain a Warning Message Contents information element. The Warning Message Contents information element contains user information (e.g., messages containing warning contents) and is broadcast via the radio interface. Upon receipt of the control message, the RAN node 12 may broadcast in the cell the warning message containing the Warning Message Contents information element. The RAN node 12 may page UEs to provide an indication (i.e., ETWS/CMAS indication) that the warning message is being broadcast.

In step 302, in response to receiving the control message in step 301, the RAN node 12 restricts access to the cell from commercial user UEs 32 and prioritizes access to the cell from government user UEs 31. For example, the RAN node 12 may restrict access from commercial user UEs 32 in one or more cells included in the area indicated by the control message in step 301. Additionally or alternatively, the RAN node 12 may decide whether to enforce access restrictions on commercial user UEs 32 by considering the content of the warning message (e.g., the Warning Message Contents information element). For example, the severity of the warning content may be considered. The RAN node 12 may enforce access restrictions on commercial user UEs 32 if the magnitude or damage level of the disaster, as estimated from the content of the warning message, exceeds a threshold. Alternatively, the RAN node 12 may determine how much to restrict access of the commercial user UEs 32 to the cell, taking into account the magnitude or damage level of the disaster.

The RAN node 12 may remove the access restrictions on commercial user UEs 32 in response to receiving a control message from the government core network 15 or the commercial core network 25 to cancel the already ongoing broadcast of the warning message. In the case of a 5G system, this control message may be a PWS CANCEL REQUEST message sent from an AMF to an NG-RAN node (e.g., gNB).

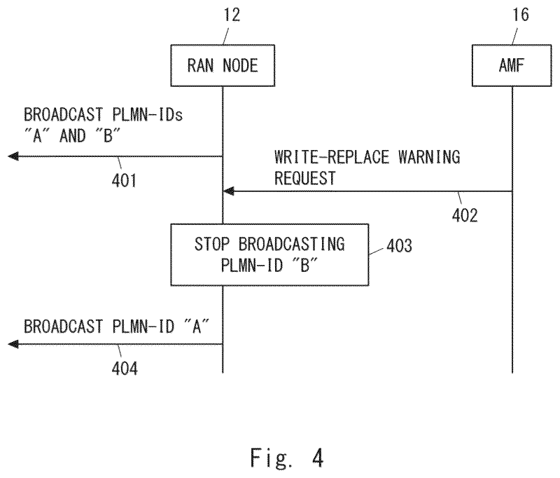

FIG. 4 shows a more specific example of the operation of the RAN node 12 shown in FIG. 3. In FIG. 4, the governmental core network 15 or the commercial core network 25 is shown as an AMF 16, which is a core network node of a 5G system. However, this is an example and other configurations may be used. For example, the AMF 16 may be replaced by another core network node in a 5G system (e.g., SMF, UDM, PCF, UPF), by a core network node in an LTE system (e.g., MME, HSS, PCRF, S-GW, P-GW), or by a core network node in another network system.

Step 401 indicates the normal state, i.e., no disaster conditions are applied to the cell or coverage area of the RAN node 12. The RAN node 12 broadcasts the PLMN ID “A” of the governmental PLMN 10 and the PLMN ID “B” of the commercial PLMN 20 in the cell.

In step 402, the AMF 16 sends a WRITE-REPLACE WARNING REQUEST message to the RAN node 12 as a control message requesting the start of the broadcast of a warning message.

In steps 403 and 404, the RAN node 12 stops broadcasting the PLMN ID “B” of the commercial PLMN 20 and broadcasts only the PLMN ID “A” in response to receiving the WRITE-REPLACE WARNING REQUEST message.

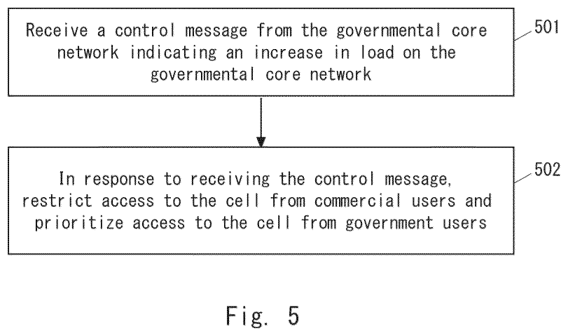

In another example, when the RAN node 12 receives a control message from the governmental core network 15 indicating an increase in load on the governmental core network 15, the RAN node 12 restricts access to the cell from the commercial user UE 32 and gives priority to access to the cell from the governmental user UE 31. FIG. 5 illustrates an example of the operation of access restriction in the cell based on the receipt of such a control message.

In step 501, the RAN node 12 receives a control message from the governmental core network 15 indicating an increase in load on the governmental core network 15.

In the case of a 5G system, the control message may be an OVERLOAD START message sent from an AMF to an NG-RAN node (e.g., gNB). The OVERLOAD START message may contain an AMF Overload Response information element. The AMF Overload Response information element indicates the required actions of the NG-RAN node in an overload situation. More specifically, the AMF Overload Response information element indicates which signaling traffic is subject to rejection by the NG-RAN node in an overload situation. Additionally or alternatively, the OVERLOAD START message may include an AMF Traffic Load Reduction Indication information element. The AMF Traffic Load Reduction Indication information element indicates the percentage of the type of traffic to be rejected, relative to the instantaneous incoming rate at the NG-RAN node. In addition or alternatively, the OVERLOAD START message may contain a Slice Overload List information element. The Slice Overload List information element indicates the list of overloaded slices. Additionally or alternatively, the OVERLOAD START message may contain information indicating the overload level or the required signaling reduction level.

In step 502, in response to receiving the control message of step 501, the RAN node 12 restricts access to the cell by commercial user UEs 32 and prioritizes access to the cell by government user UEs 31. For example, the RAN node 12 may decide whether to implement access restrictions on commercial user UEs 32 by considering the overload level or required signaling reduction level indicated by the control message of step 501. Alternatively, the RAN node 12 may determine how much to restrict access of the commercial user UEs 32 to the cell by considering the overload level or the required signaling reduction level.

The RAN node 12 may remove the access restrictions on commercial user UEs 32 in response to receiving a control message indicating that the governmental core network 15 or the AMF is no longer overloaded. In the case of a 5G system, the control message may be an OVERLOAD STOP message sent from an AMF to an NG-RAN node (e.g., gNB).

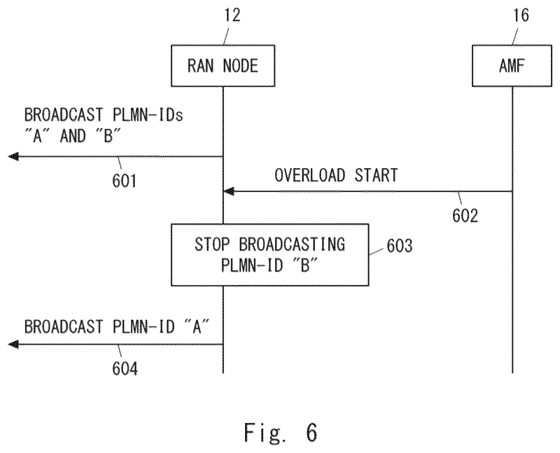

FIG. 6 shows a more specific example of the operation of the RAN node 12 shown in FIG. 5. In FIG. 6, the governmental core network 15 is shown as an AMF 16, which is a core network node of a 5G system. However, this is an example and other configurations may be used. For example, the AMF 16 may be replaced by another core network node in a 5G system (e.g., SMF, UDM, PCF, UPF), by a core network node in an LTE system (e.g., MME, HSS, PCRF, S-GW, P-GW), or by a core network node in another network system.

Step 601 indicates the normal state, i.e., the governmental core network 15 is not overloaded. The RAN node 12 broadcasts the PLMN ID “A” of the governmental PLMN 10 and the PLMN ID “B” of the commercial PLMN 20 in the cell.

In step 602, the AMF 16 sends an OVERLOAD START message to the RAN node 12 as a control message indicating the increased load on the governmental core network 15.

In steps 603 and 604, the RAN node 12 stops broadcasting the PLMN ID “B” of the commercial PLMN 20 and broadcasts only the PLMN ID “A” in response to receiving the OVERLOAD START message.

The operation of the RAN node 12 described in this example embodiment allows the RAN node 12, in response to the application of a disaster condition to the area to which a cell served by the RAN node 12 belongs or the overloading of the governmental core network 15, to restrict access to the cell by the commercial user UE 32 and to prioritizes access to the cell by the governmental user UE 31. The specific example described with reference to FIGS. 3 and 4 allows the RAN node 12, in response to a control message requesting the initiation of the broadcast of a PWS or ETWS warning message, such as an emergency earthquake or tsunami warning, to restrict access to the cell by the commercial user UE 32 and to prioritizes access to the cell by the governmental user UE 31.

The operation of the RAN node 12 described in this example embodiment (e.g., FIGS. 2-6) may be used when the RAN node 12 performs RAN sharing between any two or more PLMNs. This allows users of one PLMN to have priority over users of the other PLMN(s) to use the RAN node 12 when necessary, such as in the event of a disaster.

### Third Example Embodiment

An example configuration of a network system according to this example embodiment is the same as the example shown in FIG. 1. In this example embodiment, the governmental RAN 11 is connected to the governmental core network 15 of the governmental PLMN 10 by a first path and a second path having a longer distance than the first path. In other words, the government RAN 11 has a redundant or backup path to connect to the governmental core network 15 at a remote location that is geographically distant from the location of the government RAN 11. This can help improve the fault tolerance of the government RAN 11 and the governmental core network 15.

In some implementations, the RAN node 12 of the governmental RAN 11 may select either the first path or the second path with a longer distance than the first path to communicate with the governmental core network 15.

In some implementations, the RAN node 12 may be provided with a redundant or backup path to connect to the commercial core network 25 at a remote location, in addition to the redundant or backup path to connect to the governmental core network 15 at a remote location. The redundant or backup path for connecting to the commercial core network 25 at a remote location may be the same as, or different from, the path for connecting to the governmental core network 15.

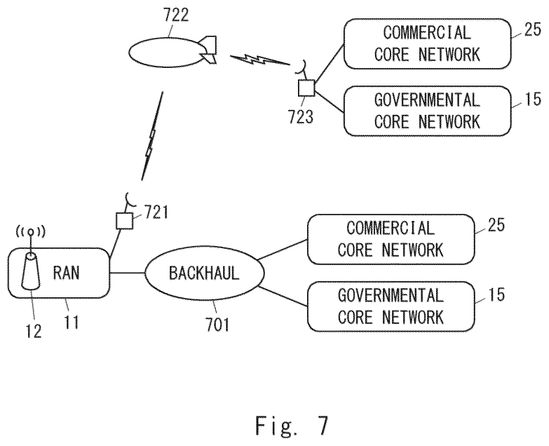

In some implementations, the second path (redundant or backup path) may use non-terrestrial communications. As shown in FIG. 7, the second path may include a wireless path that uses one or more airborne vehicles as relay stations. The one or more airborne vehicles may include, for example, an aircraft, a drone, a high-altitude pseudo-satellite (HAPS), or an artificial satellite. A high-altitude pseudo-satellite flies in the stratosphere and communicates with ground stations and other high-altitude pseudo-satellites.

In the example in FIG. 7, the RAN 11 can communicate with the governmental core network 15 and the commercial core network 25 via a backhaul 701. In addition, the RAN 11 can communicate with the governmental core network 15 and the commercial core network 25 via a backup path that includes ground stations 721 and 723 and one or more airborne vehicles 722. The backup path can be established on an emergency basis when normal communication via the backhaul 701 between the RAN 11 and the governmental core network 15 or the commercial core network 25 is not available.

### Other Example Embodiments

The example embodiments described above have focused primarily on RAN sharing between a governmental PLMN and a commercial PLMN. However, as noted above, these example embodiments can also be applied to RAN sharing between other PLMNs.

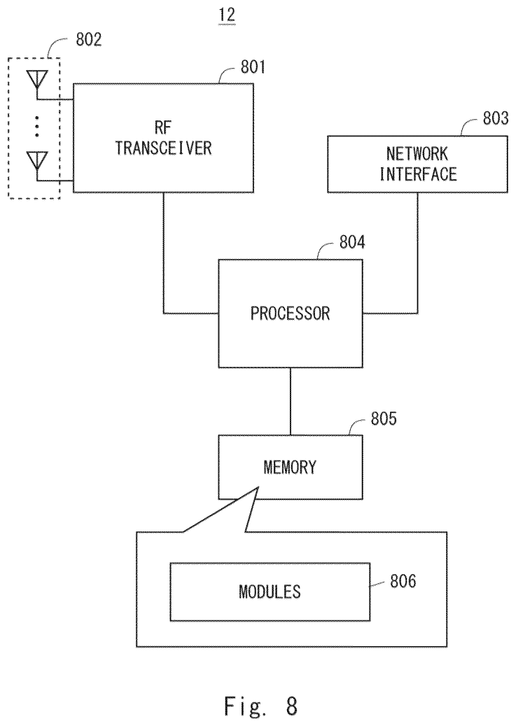

Example configurations of the RAN node 12 and the AMF 16 according to the above-described example embodiments are given below. FIG. 8 is a block diagram showing an example configuration of the RAN node 12 according to the example embodiments described above. Referring to FIG. 8, the RAN node 12 includes a Radio Frequency transceiver 801, a network interface 803, a processor 804, and a memory 805.

The RF transceiver 801 performs analog RF signal processing to communicate with UEs including the UEs 31 and 32. The RF transceiver 801 may include a plurality of transceivers. The RF transceiver 801 is coupled to an antenna array 802 and the processor 804. The RF transceiver 801 receives modulation symbol data from the processor 804, generates a transmission RF signal, and supplies the transmission RF signal to the antenna array 802. The RF transceiver 801 generates a baseband reception signal based on a reception RF signal received by the antenna array 802 and supplies the baseband reception signal to the processor 804. The RF transceiver 801 may include an analog beamformer circuit for beamforming. The analog beamformer circuit includes, for example, a plurality of phase shifters and a plurality of power amplifiers.

The network interface 803 is used to communicate with network nodes (e.g., other RAN nodes, and control plane nodes and user plane nodes in the core network). The network interface 803 may include, for example, a Network Interface Card (NIC) that complies with the IEEE 802.3 series.

The processor 804 performs digital baseband signal processing (data-plane processing) and control-plane processing for radio communication. The processor 804 may include a plurality of processors. For example, the processor 804 may include a modem processor (e.g., Digital Signal Processor (DSP)) for performing the digital baseband signal processing and a protocol stack processor (e.g., Central Processing Unit (CPU) or Micro Processing Unit (MPU)) for performing the control-plane processing.

For example, digital baseband signal processing by the processor 804 may include signal processing in the Service Data Adaptation Protocol (SDAP) layer, the Packet Data Convergence Protocol (PDCP) layer, the Radio Link Control (RLC) layer, the Medium Access Control (MAC) layer, and the Physical (PHY) layer. Control plane processing by the processor 804 may include processing of Non-Access Stratum

(NAS) messages, RRC messages, MAC Control Elements (CE), and Downlink Control Information (DCI).

The processor 804 may include a digital beamformer module for beamforming. The digital beamformer module may include a Multiple Input Multiple Output (MIMO) encoder and precoder.

The memory 805 is composed of a combination of a volatile memory and a non-volatile memory. The volatile memory is, for example, a Static Random Access Memory (SRAM), a Dynamic RAM (DRAM), or a combination thereof. The non-volatile memory may be a Mask Read Only Memory (MROM), an Electrically Erasable Programmable ROM (EEPROM), a flash memory, or a hard disk drive, or any combination thereof. The memory 805 may include a storage located away from the processor 804. In this case, the processor 804 may access the memory 805 via the network interface 803 or an I/O interface.

The memory 805 may store one or more software modules (computer programs) 806 including instructions and data for performing processing by the RAN node 12 described in the above example embodiments. In some implementations, the processor 804 may be configured to load and execute the software module(s) 806 from the memory 805, thereby performing the processing of the RAN node 12 described in the above example embodiments.

When the RAN node 12 is a Central Unit (CU) (e.g., eNB-CU or gNB-CU) or a CU Control Plane (CP) Unit, the RAN node 12 does not need to include the RF transceiver 801 (and the antenna array 802).

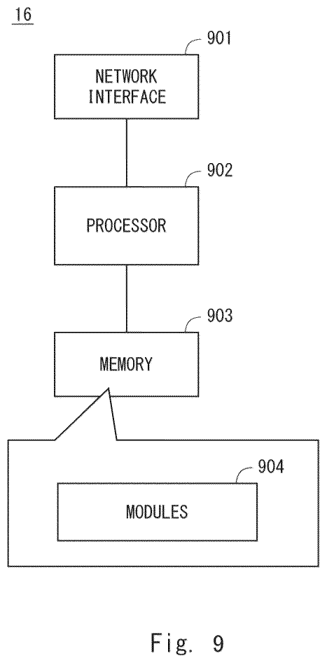

FIG. 9 shows an example configuration of the AMF 16. Referring to FIG. 9, the AMF 16 includes a network interface 901, a processor 902, and a memory 903. The network interface 901 is used, for example, to communicate with other Network Functions (NFs) or nodes. The network interface 901 may include, for example, a network interface card (NIC) compliant with the IEEE 802.3 series.

The processor 902 may be, for example, a microprocessor, a Micro Processing Unit (MPU), or a Central Processing Unit (CPU). The processor 902 may include a plurality of processors.

The memory 905 is composed of a volatile memory and a non-volatile memory. The memory 903 may include multiple physically independent memory devices. The volatile memory is, for example, a Static Random Access Memory (SRAM), a Dynamic RAM (DRAM), or a combination thereof. The non-volatile memory may be a Mask Read Only Memory (MROM), an Electrically Erasable Programmable ROM (EEPROM), a flash memory, or a hard disk drive, or any combination thereof. The memory 905 may include a storage located away from the processor 904. In this case, the processor 904 may access the memory 905 via the network interface 903 or an I/O interface.

The memory 903 may store one or more software modules (computer programs) 904 including instructions and data for performing processing by the AMF 16 described in the above example embodiments. In some implementations, the processor 902 may be configured to load and execute the software module(s) 904 from the memory 903, thereby performing the processing of the AMF 16 described in the above example embodiments.

As described using FIGS. 8 and 9, each of the processors in the RAN node 12 and the AMF 16 according to the above-described example embodiments can execute one or more programs, containing a set of instructions, to cause a computer to perform an algorithm described with reference to the drawings. Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustical, or other form of propagated signals.

The example embodiments described above are merely examples of applications of the technical ideas obtained by the inventors. These technical ideas are not limited to the example embodiments described above, and various modifications can be made thereto.

For example, the whole or part of the example embodiments disclosed above can be described as, but not limited to, the following supplementary notes.

### Supplementary Note 1

An access network node comprising:
a first communication interface configured to communicate with a plurality of User Equipments (UEs) through a cell:
a second communication interface configured to be connected to a first core network of a first Public Land Mobile Network (PLMN) and to a second core network of a second PLMN different from the first PLMN; and
at least one processor configured to:
   forward a Non-Access Stratum message that is sent from a UE and is associated with the first PLMN to the first core network, and to forward a Non-Access Stratum message that is sent from a UE and is associated with the second PLMN to the second core network; and
   restrict access to the cell from UEs using the second core network and prioritize access to the cell from UEs using the first core network in response to a disaster condition being applied to an area to which the cell belongs or an increase in load on the first core network.

### Supplementary Note 2

The access network node according to Supplementary Note 1, wherein the at least one processor is configured to restrict access to the cell from UEs using the second core network and prioritize access to the cell from UEs using the first core network in response to receiving a control message from the first core network or the second core network requesting initiation of a broadcast of a warning message.

### Supplementary Note 3

The access network node according to Supplementary Note 1 or 2, wherein the at least one processor is configured to restrict access to the cell from UEs using the second core network and prioritize access to the cell from UEs using the first core network in response to receiving a control message from the first core network indicating an increase in load on the first core network.

### Supplementary Note 4

The access network node according to any one of Supplementary Notes 1 to 3, wherein the at least one processor is configured to stop broadcasting an identifier of the second PLMN in the cell to restrict access to the cell from UEs using the second core network.

### Supplementary Note 5

The access network node according to any one of Supplementary Notes 1 to 3, wherein the at least one processor is configured to update at least one access control parameter to restrict access to the cell from UEs using the second core network,
wherein the at least one access control parameter is broadcast in the cell and used for an access barring check by UEs using the second core network of the second PLMN.

### Supplementary Note 6

The access network node according to any one of Supplementary Notes 1 to 5, wherein
the first PLMN is a non-commercial PLMN administered by a public authority, and
the second PLMN is a commercial PLMN administered by a commercial operator.

### Supplementary Note 7

The access network node according to Supplementary Note 6, wherein the access network node is administered by the non-commercial PLMN.

### Supplementary Note 8

The access network node according to any one of Supplementary Notes 1 to 7, wherein the second communication interface is connected to the first core network by a first path and a second path having a longer distance than the first path.

### Supplementary Note 9

The access network node according to any one of Supplementary Notes 1 to 7, wherein the at least one processor is configured to select either a first path or a second path having a longer distance than the first path to communicate with the first core network.

### Supplementary Note 10

The access network node according to Supplementary Note 8 or 9, wherein the second path comprises a wireless path using one or more airborne vehicles as relay stations.

### Supplementary Note 11

The access network node according to Supplementary Note 10, wherein the one or more airborne vehicles comprise at least one of an aircraft, a drone, a high-altitude pseudo-satellite, or an artificial satellite.

### Supplementary Note 12

The access network node according to Supplementary Note 10, wherein the one or more airborne vehicles comprise a high-altitude pseudo-satellite flying in the stratosphere.

### Supplementary Note 13

A method performed by an access network node, the method comprising:
connecting to a first core network of a first Public Land Mobile Network (PLMN) and to a second core network of a second PLMN different from the first PLMN;
communicating with a plurality of User Equipments (UEs) through a cell:
forwarding a Non-Access Stratum message that is sent from a UE and is associated with the first PLMN to the first core network, and forwarding a Non-Access Stratum message that is sent from a UE and is associated with the second PLMN to the second core network: and
restricting access to the cell from UEs using the second core network and prioritizing access to the cell from UEs using the first core network in response to a disaster condition being applied to an area to which the cell belongs or an increase in load on the first core network.

### Supplementary Note 14

The method according to Supplementary Note 13, wherein said restricting and prioritizing comprises restricting access to the cell from UEs using the second core network and prioritizing access to the cell from UEs using the first core network in response to receiving a control message from the first core network or the second core network requesting initiation of a broadcast of a warning message.

### Supplementary Note 15

The method according to Supplementary Note 13 or 14, wherein said restricting and prioritizing comprises restricting access to the cell from UEs using the second core network and prioritizing access to the cell from UEs using the first core network in response to receiving a control message from the first core network indicating an increase in load on the first core network.

### Supplementary Note 16

The method according to any one of Supplementary Notes 13 to 15, further comprising stopping broadcasting an identifier of the second PLMN in the cell to restrict access to the cell from UEs using the second core network.

### Supplementary Note 17

The method according to any one of Supplementary Notes 13 to 15, further comprising updating at least one access control parameter to restrict access to the cell from UEs using the second core network,
wherein the at least one access control parameter is broadcast in the cell and used for an access barring check by UEs using the second core network of the second PLMN.

### Supplementary Note 18

The method according to any one of Supplementary Notes 13 to 17, wherein
the first PLMN is a non-commercial PLMN administered by a public authority, and
the second PLMN is a commercial PLMN administered by a commercial operator.

### Supplementary Note 19

The method according to Supplementary Note 18, wherein the access network node is administered by the non-commercial PLMN.

### Supplementary Note 20

The method according to any one of Supplementary Notes 13 to 19, further comprising selecting either a first path or a second path having a longer distance than the first path to communicate with the first core network.

### Supplementary Note 21

The method according to Supplementary Note 20, wherein the second path comprises a wireless path using one or more airborne vehicles as relay stations.

### Supplementary Note 22

The method according to Supplementary Note 21, wherein the one or more airborne vehicles comprise at least one of an aircraft, a drone, a high-altitude pseudo-satellite, or an artificial satellite.

### Supplementary Note 23

The method according to Supplementary Note 21, wherein the one or more airborne vehicles comprise a high-altitude pseudo-satellite flying in the stratosphere.

### Supplementary Note 24

A program for causing a computer to perform a method for an access network node, the method comprising:
connecting to a first core network of a first Public Land Mobile Network (PLMN) and to a second core network of a second PLMN different from the first PLMN:
communicating with a plurality of User Equipments (UEs) through a cell:
forwarding a Non-Access Stratum message that is sent from a UE and is associated with the first PLMN to the first core network, and forwarding a Non-Access Stratum message that is sent from a UE and is associated with the second PLMN to the second core network: and
restricting access to the cell from UEs using the second core network and prioritizing access to the cell from UEs using the first core network in response to a disaster condition being applied to an area to which the cell belongs or an increase in load on the first core network.

### Supplementary Note 25

A network system comprising:
a core network of a non-commercial Public Land Mobile Network (PLMN) administered by a public authority: and
a non-commercial radio access network node administered by the public authority, wherein
the non-commercial radio access network node is configured to be connected to the core network of the non-commercial PLMN and to a core network of a commercial PLMN administered by a commercial operator, and
the non-commercial radio access network node is configured to:
   forward a Non-Access Stratum message that is sent from a User Equipment (UE) and is associated with the non-commercial PLMN to the core network of the non-commercial PLMN: and
   forward a Non-Access Stratum message that is sent from a UE and is associated with the commercial PLMN to the core network of the commercial PLMN.

### Supplementary Note 26

The network system according to Supplementary Note 25, wherein the non-commercial radio access network node is configured to, in response to a disaster condition being applied to an area to which a cell served by the non-commercial radio access network node belongs, restrict access to the non-commercial radio access network node from UEs using the core network of the commercial PLMN and prioritize access to the non-commercial radio access network node from UEs using the core network of the non-commercial PLMN.

### Supplementary Note 27

The network system according to Supplementary Note 25 or 26, wherein the non-commercial radio access network node is configured to, in response to receiving a control message from the core network of the non-commercial PLMN or the core network of the commercial PLMN requesting the initiation of a broadcast of a warning message, restrict access to the non-commercial radio access network node from UEs using the core network of the commercial PLMN and prioritize access to the non-commercial radio access network node from UEs using the core network of the non-commercial PLMN.

### Supplementary Note 28

The network system according to any one of Supplementary Notes 25 to 27, wherein the non-commercial radio access network node is configured to, in response to increased load on the core network of the non-commercial PLMN, restrict access to the non-commercial radio access network node from UEs using the core network of the commercial PLMN and prioritize access to the non-commercial radio access network node from UEs using the core network of the non-commercial PLMN.

### Supplementary Note 29

The network system according to any one of Supplementary Notes 26 to 28, wherein the non-commercial radio access network node is configured to stop broadcasting an identifier of the commercial PLMN to restrict access to the non-commercial radio access network node from UEs using the core network of the commercial PLMN.

### Supplementary Note 30

The network system according to any one of Supplementary Notes 26 to 28, wherein the non-commercial radio access network node is configured to update at least one access control parameter to restrict access to the non-commercial radio access network node from UEs using the core network of the commercial PLMN,
wherein the at least one access control parameter is broadcast by the non-commercial radio access network node and used for an access barring check by UEs using the core network of the commercial PLMN.

### Supplementary Note 31

The network system according to any one of Supplementary Notes 25 to 30, wherein the non-commercial radio access network node is connected to the core network of the non-commercial PLMN by a first path and a second path having a longer distance than the first path.

### Supplementary Note 32

The network system according to any one of Supplementary Notes 25 to 30, wherein the non-commercial radio access network node is configured to select either a first path or a second path having a longer distance than the first path to communicate with the core network of the non-commercial PLMN.

### Supplementary Note 33

The network system according to Supplementary Note 31 or 32, wherein the second path comprises a wireless path using one or more airborne vehicles as relay stations.

### Supplementary Note 34

The network system according to Supplementary Note 33, wherein the one or more airborne vehicles comprise at least one of an aircraft, a drone, a high-altitude pseudo-satellite, or an artificial satellite.

### Supplementary Note 35

The network system according to Supplementary Note 33, wherein the one or more airborne vehicles comprise a high-altitude pseudo-satellite flying in the stratosphere.

### Reference Signs List

10 Governmental PLMN
11 Governmental RAN
12 RAN Node
15 Governmental Core Network
16 AMF
20 Commercial PLMN
25 Commercial Core Network
31 Governmental User UE
32 Commercial User UE
721 Ground Station
722 Airborne Vehicle
723 Ground Station
804 Processor
805 Memory
806 Modules
902 Processor
903 Memory
904 Modules

What is claimed is:

1-35. (canceled)

36. A method performed by a base station of a first Public Land Mobile Network (PLMN), the method comprising:
identifying a disaster situation; and
configuring a network sharing with a second PLMN based on the identified disaster situation.

37. The method according to claim 36, further comprising:
including an identifier of the second PLMN in broadcast information, in a case where the base station configures the network sharing.

38. The method according to claim 37, further comprising:
disabling the network sharing based on the identified disaster situation; and
excluding the identifier of the second PLMN from the broadcast information, in a case where the base station disables the network sharing.

39. A method performed by a User Equipment (UE), the method comprising:
accessing a service of a second Public Land Mobile Network (PLMN) based on a disaster situation; and
obtaining the service of the second PLMN.

40. The method according to claim 39, further comprising:
receiving, from a base station of a first PLMN, broadcast information that includes an identifier of the second PLMN,
wherein the broadcast information is broadcasted based on the disaster situation.

41. A base station of a first Public Land Mobile Network (PLMN), the base station comprising:
at least one processor; and
at least one memory including computer program code,
wherein the at least one memory and the computer program code are configured, with the at least one processor, to cause the base station to:
identify a disaster situation; and
configure a network sharing with a second PLMN based on the identified disaster situation.

42. A User Equipment (UE) comprising:
at least one processor; and
at least one memory including computer program code,
wherein the at least one memory and the computer program code are configured, with the at least one processor, to cause the UE to:
access a service of a second Public Land Mobile Network (PLMN) based on a disaster situation; and
obtain the service of the second PLMN.

43. A non-transitory computer readable medium storing one or more programs, the one or more programs comprising instructions, which when executed by one or more processors of a base station of a first Public Land Mobile Network (PLMN) to cause the base station to:
identify a disaster situation; and
configure a network sharing with a second PLMN based on the identified disaster situation.

44. A non-transitory computer readable medium storing one or more programs, the one or more programs comprising instructions, which when executed by one or more processors of a User Equipment (UE) to cause the UE to:
access a service of a second Public Land Mobile Network (PLMN) based on a disaster situation; and
obtain the service of the second PLMN.
